(19) United States
(12) Patent Application Publication
(10) Pub. No.: US 2009/0302689 A1
(43) Pub. Date: Dec. 10, 2009

(54) HARMONIC ABSORBER

(76) Inventor: Kemal Isleyen, Istanbul (TR)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/162,622

(22) PCT Filed: Jan. 29, 2007
(86) PCT No.: PCT/IB07/50290

§ 371 Date: Dec. 18, 2008

(30) Foreign Application Priority Data
Jan. 30, 2006 (TR) 2006/00371

(51) Int. Cl. H02M 1/12

(52) U.S. Cl. 307/105

(57) ABSTRACT

This is a harmonic absorber (14) for eliminating the harmonics occurring due to unbalanced loads in a network transformer (1), a power factor correction system (6) to correct the cos φ value of the system to which it has been connected and an electrical system comprising electrical loads (7), and it contains at least one harmonic hole circuit (13), which consists of power reactance inductors (13.1) and power capacitors (13.2), and a harmonic separating circuit (12), which separates the harmonics existing in the network from the other components in the network and then, in order to achieve the elimination of each individual harmonic achieved in this manner, applies them to the mentioned hole circuit (13).

### FIELD OF THE INVENTION

This invention is based on a system which eliminates the harmonic voltage and eliminates the harmonic currents which occur in low voltage networks.

### BACKGROUND OF THE INVENTION

Harmonics are the periodic distortions caused on the sinusoidal waves related to current, voltage or power. It is accepted that their amplitudes are a combination of waveform, different frequencies and the various sinusoidal waves. Harmonics are mainly the results of the non-linear loads of adjustable motor speed drivers or direct current power supplies of computers and televisions. These harmonics cause overheating of transformers, conductors and motors.

When investigating the existing harmonic filters or absorbers, they were insufficient for eliminating these harmonics totally from the network. These products, which are mainly based on dynamic and passive harmonic filters, are widely distributed in the market. The passive ones are designed to eliminate only a certain level of the harmonics. So they are incapable of eliminating the different levels of harmonics added to the networks or the different levels of harmonics on the currents that different loads create. In these systems, the existing passive harmonic filter or absorber should be eliminated and the new harmonic level should be measured and a new passive harmonic filter or absorber should be designed for the system. Additionally there will be a need to replace the new compensation systems or change the power capacitors, because the new total voltage generated after the new harmonics will be less than the amount of voltage of the compensation system's power capacitors. The aim of the dynamic absorbers or the filters in the market today is to easily make the adaptation of the additional loads or to remove the loads from the system. But in reality, after the measurements done, this system may only help to eliminate 1% or 2% of the other levels of the harmonics; this means there is no great effect and benefit. In fact it has been observed that, while eliminating a certain percentage of the other levels of the harmonics, it triggered some levels of the harmonics to higher values.

In international standards, institutions have legal restrictions to eliminate the harmonics or to lower the harmonics to certain levels. According to IEC (International Electric Cooperation) the total harmonic distortion based on the voltage should not be more than 3%, and on the current should not be more than 6%. Also based on the IEEE standard 519, all electrical systems should have lower harmonic distortions to protect against damage.

As a result, to eliminate the harmonics on the networks without triggering other levels of the harmonics and without adding any additional cost when there is a new load on the network which creates another level of harmonics, these problems inspired us to work in the area and make this invention.

### SUMMARY OF THE INVENTION

The current invention is related to a harmonic absorber, which meets the above-mentioned requirements, eliminates all of the disadvantages and brings certain advantages.

The purpose of the invention is to put forward a structure that ensures the complete annihilation of all of the harmonics occurring in the network.

Another purpose of the invention is to establish a harmonic absorbing structure, which provides flexibility in the system, and without the need for a structural change, takes an additional new harmonic absorber into service, in case the equipment connections, which result in a rise of the harmonic currents, increase in the voltage network.

A further purpose of the invention is establishing a harmonic absorber, which does not necessitate any modification in the existing power factor correction structure in the system.

Another purpose of the invention is putting forward a harmonic absorber that eliminates all harmonic currents and voltages and reduces the electrical energy drawn from the network and hence, provides a decrease in the costs.

A further purpose for the invention is creating a harmonic absorber, which, apart from ensuring the reduction of energy losses in the facility where it has been connected, causes the protection of the life times of the equipment that may be damaged from the harmonics.

Furthermore, the invention is aimed at providing a harmonic absorber that eliminates the power outages caused by harmonic currents and voltages.

The invention provides a harmonic absorber according to claim 1 and a method for absorbing harmonics according to claim 9. Optional features of the invention are set out in the dependent claims.

The structural and characteristic properties and the advantages of the invention will be understood better after seeing the figures given below and reading the detailed explanations written referring to these figures and therefore the evaluation should be done considering these figures and the detailed explanation.

### BRIEF DESCRIPTION OF THE DRAWINGS

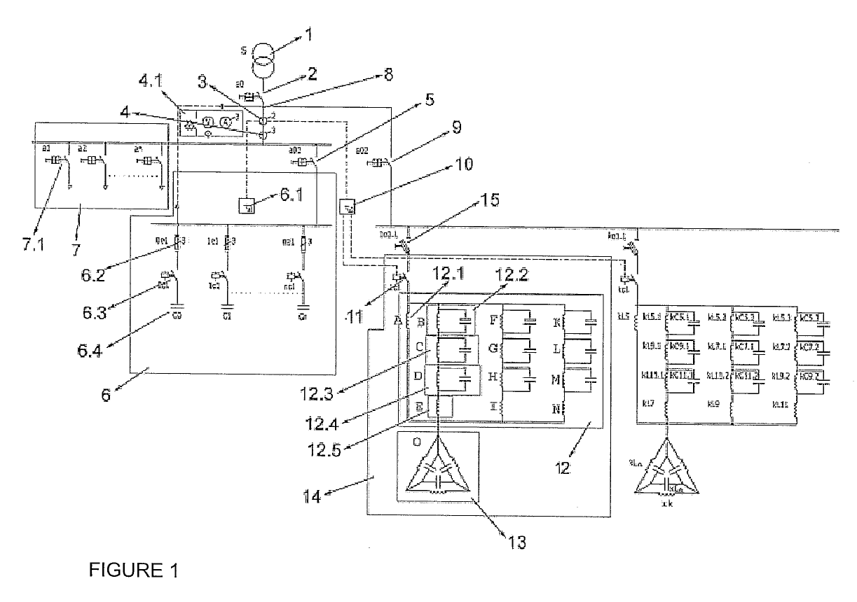

In FIG. 1, the open electrical circuit layout that shows the preferred structure of the connection between the newly discovered harmonic absorber and the system is given.

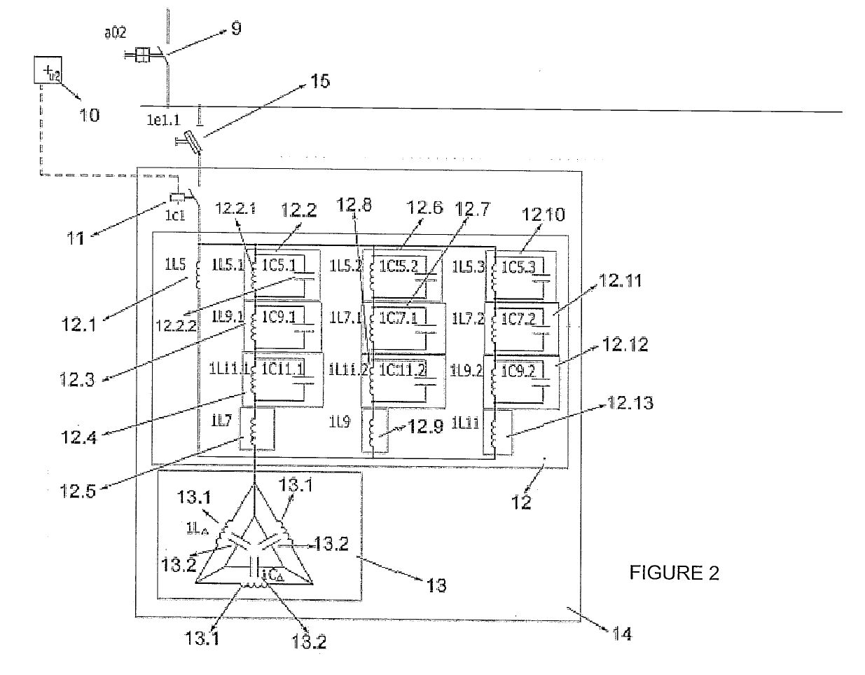

In FIG. 2, the detail of the open electrical circuit diagram related to the structure that constitutes the newly discovered harmonic absorber is given.

### THE REFERENCE NUMBERS USED FOR THE DRAWINGS

| | |
|---|---|
| 1. | Network transformer |
| 2. | Main switch |
| 3. | Current tranformer for controlling relays |
| 4. | Current transformer for measurement devices |
| 4.1. | Measurement devices and NH circuit-breaker |
| 5. | Power factor correction protection switch |
| 6. | Power factor correction circuit |
| 6.1. | A reactive correction power control relay |
| 6.2. | Circuit-breaker |
| 6.3. | The element for taking the power capacitor into service |
| | (contactor and/or tristor) |
| 6.4. | Power capacitor of Power factor correction |
| 7. | The loads connected to the system |
| 7.1. | Switches for loads |
| 8. | Harmonic absorber special connection point |
| 9. | Harmonic absorber protection switch |
| 10. | Harmonic block selection element |
| 11. | The element for taking the harmonic absorber block into |
| | (contactor and/or tristor) |
| 12. | Harmonic separator |
| 12.1. | 5th harmonic transferors |
| 12.2. | 5th harmonic barrier circuit |
| 12.2.1. | Power reactance inductor |
| 12.2.2. | Power capacitor |
| 12.3. | 9 th harmonic barrier circuit |
| 12.4. | 11 th harmonic barrier circuit |
| 12.5. | 7 th harmonic transferors |
| 12.6. | 5 th harmonic barrier circuit |
| 12.7. | 7 th harmonic barrier circuit |
| 12.8. | 11 th harmonic barrier circuit |
| 12.9. | 9 th harmonic transferors |
| 12.10. | 5 th harmonic barrier circuit |
| 12.11. | 7 th harmonic barrier circuit |
| 12.12. | 9 th harmonic barrier circuit |
| 12.13. | 11 th harmonic transferors |
| 13. | Harmonic hole |
| 13.1. | Harmonic hole power reactance inductor |
| 13.2. | Harmonic hole power capacitors |
| 14. | Harmonic absorber |
| 15. | Harmonic absorber circuit-breaker |

### DETAILED EXPLANATION OF THE INVENTION

In this detailed explanation, the preferred structuring of the harmonic absorber (eliminator) is explained in an easily understood manner so that it can be better understood, without any limiting influence.

There is a protection switch (9) selected according to the total value of the harmonic currents, in the circuit acting as a protection element, which opens the circuit without damaging the circuit, and consequently the elements that may occur due to the increasing harmonics in the circuit. Moreover, for the safety of the whole system, a main switch (2) should be included as a protection element. The connection point (8) of this element (2) is very important for the subject of the invention, the harmonic absorber (14), and is right after the current transformers (3, 4) and the connection points of the other relays (6.1, 10), i.e. the distribution point of the current drawn from the network. In other words, one end of the switch (2) should definitely be connected to the network transformer and the other end, with the connection point (8) of the protective elements (5, 7.1, 9). Moreover, at the inputs of the harmonic absorber layers (14), load separators (11) with circuit breakers are positioned. When choosing these load separators, it is preferred to take into consideration a current (1/k)*1.2 times the total harmonic current value. If a contactor is used as the NH circuit breaker, to have the ideal working condition, it should be selected as a zero conducting solid-state type or the super flinck (?) type.

The harmonic block selection unit (10), shown in FIG. 1, is preferably a harmonic relay available in the market and can be specially manufactured by calculation according to the amount of the harmonic currents. The purpose of this relay (10) is to take the harmonic absorber (14) into service and to electrically open or close its elements. As the above-mentioned element for taking into operation (11), contactors or zero conducting solid-state relays (contactors and/or thyristors) can be used. The current transformers (3, 4), which will be connected to the system, are selected according to the power of the transformer from which they are fed and are responsible for measuring the currents drawn by the receivers (4.1, 6.1, 10) after them.

In order to take the power factor correction (6) into the circuit, a reactive correction power control relay (6.1) can be used. Through this relay (6.1), it will be possible to select the line or lines where the power capacitor (6.4), whose power factor correction will be realized, shall be taken into the circuit. In order to carry out this process, the elements whose above-mentioned control relay (6.1) outputs are positioned in each line and preferably, which comprise contactors or thyristors are used for taking the power capacitor into service (6.3). By installing circuit-breakers at the beginning of each line, the protection of the system is targeted.

The loads connected to the system (7) may be connected via relevant switches (7.1) to the network. Thus, we arrive at a principal electrical circuit (FIG. 1), which is used for connecting the loads (7), which are fed by the network transformer (1) and the power factor correction (6), which is used for power factor correction of the system, in an existing system. The mentioned structure is standard and represents the connections, which are generally used in all establishments. Here the objective is to focus on the important points for the connection of the harmonic absorber (14), which is the subject of the invention, to the system and to provide a better insight of how it works together with the system.

In order for the harmonic absorber (14) to be used effectively, as mentioned above, it should be connected to the system, especially directly after the main switch (2). And directly after this connection point, the current transformer (3), which will take the harmonic absorber (14) appropriate for the system into service and which will feed the harmonic block selection element (10), preferably a relay with multiple outputs (10), is connected to the relevant line. This harmonic absorber relay (10) takes into operation the harmonic absorber block or blocks (14), according to the types and amounts of the harmonic currents occurring in the network. A harmonic absorber block (14) comprises a harmonic barrier circuit (stopper) (12.2, 12.3, 12.4 etc.), whose values are calculated according to the types and amplitudes of the harmonics desired to be eliminated, as well as a harmonic separator with transferors (12.1, 12.5 etc.). Here, the purpose is to apply the harmonic signals (waves) to the input of the harmonic hole circuit (regarded as a harmonic hole), after separating them from each other and then, eliminate them here.

The harmonic hole (13) eliminates each of these harmonic currents that come from the harmonic separator (12) and that are separated from the network and hence, ensures that these harmonic currents and consequently, the harmonic voltages, which are, as mentioned in the beginning, are created by non-linear loads and are unwanted because of their unwanted effects, are eliminated from the network and the network is cleaned. In the system in FIG. 1, which has been designed for a three-phase system, preferably, a delta connected harmonic hole (13) is used. However, in three-phase and/or single-phase electric circuits, it is possible to realize the same function by making a star connection. In the harmonic hole (13); parallel connected harmonic hole power reactance inductors (13.1) and power capacitors (13.2) are used. The dimensions of these are calculated according to the amplitude of the current drawn from the circuit and the components of the harmonic currents that are requested to be eliminated, i.e. especially their frequencies. When the harmonic hole is used, in a three-phased system, as a delta circuit, as indicated in the preferred structure of FIG. 2, each corner of the triangle is connected to the output of the harmonic separators taken from different phases. Moreover, instead of this structure, the harmonic hole circuit can also be realized by applying each specific harmonic current that is requested to be damped, separately to the circuits comprising power reactance inductors and power capacitors, connected in parallel, as in the harmonic barrier circuits (12.2, 12.3 etc). However, as a technical expert can easily understand, the use of the above-mentioned delta structure as a harmonic hole (13) reduces the number of connections and simplifies the system and hence, enables the establishment of a meaningful structure.

The purpose of using the harmonic separator circuit (12) is to attract certain components of harmonic currents to it, then separate them from each other and eliminate them by applying them to the harmonic hole (13). Access of harmonic currents, which are not desired to pass, to the harmonic hole (13) is prevented using harmonic barrier circuits (12.2, 12.3, etc.), whose value is determined by calculating according to each harmonic current. Attraction of each harmonic current to the harmonic separator block (12) and then to the harmonic hole (13) is enabled by harmonic transferors (12.1, 12.5, and 12.9), which are designed according to the properties of harmonic current that is required to pass. Here, the number of the harmonic barrier circuits used (12.2, 12.3, etc), is proportional to the number of the harmonic currents that are required to be damped. On the other hand, the number of harmonic absorber blocks (14) may be any desired according to the amplitudes of the harmonic currents, which are required to be filtered from the network. The harmonic currents are distributed to the mentioned harmonic blocks (12), via the above mentioned harmonic relay (10). Each output of this harmonic relay (10) triggers the load separating element (11) of the relevant harmonic block and thus connection or disconnection of the required harmonic block (12) according to the specified conditions is provided. The output of the harmonic relay (10) preferably works with multiplexing logic. For example, when the amount of total harmonic current exceeds the load capacity of a harmonic block (12), which is designed in accordance with a harmonic current of specific amplitude, it can connect other blocks (12) in accordance with the requirements. So, the total harmonic current is distributed to the separator blocks (12).

In the invention, when examined as a practical method, to attenuate and to absorb the harmonic currents, it seems necessary to separate them, primarily from the network and then from each other. Here, via a harmonic separator (12), which enters into the circuit at the appropriate time according to the values of the harmonic currents, the harmonic currents are separated from the network and from each other. Through power reactance inductors wound at values suitable for each harmonic current component, these harmonic currents are drawn towards the above-mentioned harmonic separator (12). Moreover, they are eliminated by a harmonic hole (13), established for the damping of the individual harmonic currents, achieved at the output of the harmonic separator (12). The harmonic hole here (13), as mentioned above, can be made of star or delta connected parallel power reactance inductors (13.1) and power capacitors (13.2) orit can be made of parallel connected power reactance inductors and power capacitors, designed individually for each harmonic current and positioned dispersedly. In implementation, the most preferred way is the triad connection, as shown in FIG. 1 and FIG. 2.

For example, in the structure preferred in FIG. 2, the harmonic separator draws the 5th, 7th, 9th and 11th harmonics from the network and after separating them, conveys them to the harmonic hole (13). The 5th harmonic transferor (12.1) draws only this harmonic current to itself and does not affect the other harmonic currents. The 5th, 9th and 11th harmonic barrier circuits (12.6, 12.7 and 12.8), belonging to the second branch, are serially connected and these harmonic currents are filtered and only the 7th harmonic is conveyed to the harmonic hole (13) via a power reactance inductor (12.5). Similarly, in the third branch, the 5th, 7th and 11th harmonic current barrier circuits (12.6, 12.7, and 12.8) prevent the passage of these harmonics and via a 9th harmonic transferor (12.9), serially connected to these, the 9th harmonic is conveyed to the output. And in order to pass the 11th harmonic, the 5th, 7th and 9th harmonic barrier circuits (12.10, 12.11 and 12.13) and an 11th harmonic transferor is used. As mentioned before, the number of branches where each individual harmonic current shall be drawn and the number of harmonic barrier circuits (12.2, 12.3, etc.) can vary according to the number of harmonic currents that are requested to be eliminated.

In determining the real values of a harmonic absorber that can be used in such a system an approach may be provided as follows, by calculating the numeric values with formulae and without forming a limiting factor:

First, a measurement is done with a harmonic analyzer at the Low Voltage network.
1) S, transformer power in VA.
2) UK, is obtained from the transformer's label.
3) Harmonic currents are measured.
I₃=3^{rd} harmonic current value in Amperes (A).
I₅=5^{th} harmonic current value in Amperes (A).
I₇=7^{th} harmonic current value in Amperes (A).
I₉=9^{th} harmonic current value in Amperes (A).
I₁₁=11^{th} harmonic current value in Amperes (A).

The 3^{rd} harmonic current value disappears in the network because of delta connected motors or heaters present in the low voltage network. Therefore a unit to eliminate this value is not placed in the harmonic absorber. However, if there are too few or no delta connected takers in the low voltage system, the third harmonic unit is added to the system.

In our sample diagram, practically the most common 5^{th}-7^{th}-9^{th}-11^{th} harmonic values are considered and drawn. If other harmonic levels are encountered during measurements, principally the numbers of the harmonic collector circuits we implement are increased. In accordance with the requirements in the system, one or more of the 5^{th}-7^{th}-9^{th}-11^{th} harmonic collectors may be removed.

The example below may be presented in order to show the measurements in numeric values:

| S = 1600 kVA | uₖ = %6 | u = 400 V | I = 2000 A |
|---|---|---|---|
| I₅ = %20 I = 400 A | V₅ = 8.88 V | | |
| I₇ = %25 I = 500 A | V₇ = 15.55 V | | |
| I₉ = %15 I = 300 A | V₉ = 11.99 V | | |
| I₁₁ = %10 I = 200 A | V₅ = 9.77 V | | |

Total harmonic current I₂=\sqrt{I₅²+I₇²+I₉²+I₁₁²} \sqrt{400²+500²+300²+200²}=734,84A The calculation of the value of the power capacitor to eliminate these harmonic currents:

Q=\sqrt{3}*I_{d}*u=\sqrt{3}*734,84*400=509112 VAr≈500 kVAr

Because the most economical solution for the application is 50 kVAr; it is calculated as

$$k = \frac{500}{50} = 10$$

$${C}_{Δ} = \frac{{Q}_{c}}{3 * {u}^{2} * 100 π} = \frac{500}{3 * {400}^{2} * 100 π} = 331 , 4393 µF$$

$${C}_{λ} = 3 * {C}_{Δ} = 3 * 331 , 4393 = 994 , 31779 µF$$

After these calculations, to find the value of the LA power reactance inductor:

$${L}_{Δ} = \frac{1}{{C}_{Δ} * 100 π} = \frac{{10}^{6}}{331 , 4393 * 100 π} = 30.545 , 46 µH$$

We accept L_{Δ}=30.550 μH, because of the manufacturing possibilities for power reactance inductor (due to which we should round the last digits to the value of 10 or 10 times).

$${L}_{λ} = \frac{{L}_{Δ}}{3} = \frac{30.550}{3} = 10.183 , 33 µH$$

When the harmonic currents are passed to the collector circuits:

$${x}_{5} = \frac{{V}_{5}}{{I}_{5}^{′}} = \frac{8 , 88}{( 400 \text{/} 10 )} = 0 , 222 Ω$$

$${x}_{A 5} = {L}_{5} * 500 π$$

The 5th harmonic current, may only pass -A- section and than go to -O- harmonic hole, because there are 5th harmonic barriers in the other circuits.

$$\begin{matrix}\frac{1}{{x}_{C 5}} = \frac{1}{{L}_{1 λ} * 500 π} - {C}_{λ} * 500 π \\ = \frac{{10}^{6}}{10.183 , 33 * 500 π} - 994 , 3179 * {10}^{- 6} * 500 π\end{matrix}$$

$${x}_{C 5} = - 0 , 6666627$$

$${x}_{5} = 0 , 222 = {L}_{5} * 500 π - 0 , 66666627$$

$${L}_{5} = 565 , 512627 \approx 570 µH ( rounding of )$$

$${I}_{7}^{′} = \frac{500}{10} = 50 A$$

Here we calculate the value of the power capacitors in this circuit, because the part of this harmonic current with the higher value will pass from B-E circuit:

C_{5.1}=C_{9.1}=C_{11.1}

Q₇=\sqrt{3}*50*400=34.640 Var

We round off this value to Q₇=40 kVAr.

$${C}_{5.1} = {C}_{9.1} = {C}_{11.1} = \frac{40.000}{3 * {400}^{2} * 100 π} = 265 , 15 µF$$

The calculation of the values of the power reactance inductors will be as below, because these power capacitors will be used as the 5-9-11 th harmonic barrier circuits.

$$\begin{matrix}{L}_{5.1} = \frac{1}{{C}_{5.1} * {( 500 π )}^{2}} \\ = \frac{{10}^{6}}{265 , 15 * {( 500 π )}^{2}} \\ = 1.527 , 28 \approx 1.530 µH\end{matrix}$$

$$\begin{matrix}{L}_{9.1} = \frac{1}{{C}_{9.1} * {( 900 π )}^{2}} \\ = \frac{{10}^{6}}{265 , 15 * {( 900 π )}^{2}} \\ = 471 , 38 \approx 470 µH\end{matrix}$$

$$\begin{matrix}{L}_{11.1} = \frac{1}{{C}_{11.1} * {( 1100 π )}^{2}} \\ = \frac{{10}^{6}}{265 , 15 * {( 1100 π )}^{2}} \\ = 315 , 55 \approx 320 µH\end{matrix}$$

$$\begin{matrix}{x}_{A 7} = {L}_{5} * 700 π \\ = 570 * {10}^{- 6 } * 700 π \\ = 1 , 254 Ω\end{matrix}$$

$$\begin{matrix}\frac{1}{{x}_{B 7}} = \frac{1}{{L}_{5.1} * 700 π} - {C}_{5.1} * 700 π \\ = \frac{{10}^{6}}{1.530 * 700 π} - 265 , 15 * {10}^{- 6} * 700 π\end{matrix}$$

$${x}_{B 7} = - 3 , 4935539 Ω$$

$$\begin{matrix}\frac{1}{{x}_{C 7}} = \frac{1}{{L}_{9.1} * 700 π} - {C}_{9.1} * 700 π \\ = \frac{{10}^{6}}{470 * 700 π} - 265 , 15 * {10}^{- 6} * 700 π\end{matrix}$$

$${x}_{C 7} = 2 , 605605 Ω$$

$$\begin{matrix}\frac{1}{{x}_{D 7}} = \frac{1}{{L}_{11.1} * 700 π} - {C}_{11.1} * 700 π \\ = \frac{{10}^{6 }}{320 * 700 π} - 265 , 15 * {10}^{- 6} * 700 π\end{matrix}$$

$${x}_{D 7} = 1 , 194565 Ω$$

$${x}_{E 7} = {L}_{7} * 700 π = 2.200 * {L}_{7}$$

$${x}_{( B - E ) 7} = - 3 , 4935539 + 2 , 605605 + 1 , 194565 + 2.200 {L}_{7}$$

$${x}_{( B - E )} = 2.200 {L}_{7} + 0 , 306616 \\ \begin{matrix}\frac{1}{{x}_{( A - E ) 7}} = \frac{1}{1 , 254} + \frac{1}{2.200 {L}_{7} + 0 , 306616} \\ = \frac{2.200 {L}_{7} + 1 , 560616}{2.758 , 8 {L}_{7} + 0 , 384496}\end{matrix} \\ {x}_{( A - E ) 7} = \frac{2.758 , 8 {L}_{7} + 0 , 384496}{2.200 {L}_{7} + 1 , 560616} \\ \begin{matrix}\frac{1}{{x}_{O 7}} = \frac{1}{{L}_{λ} * 700 π} - {C}_{λ} * 700 π \\ = \frac{{10}^{6}}{10.183 , 33 * 700 π} - 994 , 3179 * {10}^{- 6} * 700 π\end{matrix} \\ {x}_{O 7} = - 0 , 466665 Ω$$

$${x}_{7} = \frac{{V}_{7}}{{I}_{7}} = {x}_{( E - A ) 7} + {x}_{O 7}$$

$$\begin{matrix}{x}_{7} = \frac{15 , 55}{( 500 / 10 )} \\ = 0 , 311 \\ = \frac{2.758 , 8 {L}_{7} + 0 , 384496}{2.200 {L}_{7} + 1 , 560616} - 0 , 466665\end{matrix}$$

$$0 , 777665 = \frac{2.758 , 8 {L}_{7} + 0 , 384496}{2.200 {L}_{7} + 1 , 560616}$$

$$1.710 , 863 {L}_{7} + 1 , 213636 = 2.758 , 8 {L}_{7} + 0 , 384496$$

$$1.047 , 937 {L}_{7} = 0 , 82914 \\ {L}_{7} = 791 , 21 \approx 790 µH$$

$${I}_{9}^{′} = \frac{300}{10} = 30 A$$

Here, we calculate the power capacitor values in this circuit, because the higher value of this harmonic current will pass from A and (F-I) circuits: C_{5.2}=C_{7.1}=C_{9.2}

Q₉=\sqrt{3}*30*400=20.784 Var

We round off this value as Q₇=30 kVAr.

$${C}_{5.2} = {C}_{7.1} = {C}_{9.2} = \frac{30.000}{3 * {400}^{2} * 100 π} = 198 , 8636 µF$$

The calculation of the values of the power reactance inductors will be as below, because these power capacitors will be used as the 5-7-11 th harmonic barrier circuits.

$$\begin{matrix}{L}_{5.2} = \frac{1}{{C}_{5.2} * {( 500 π )}^{2}} \\ = \frac{{10}^{6}}{198 , 8636 * {( 500 π )}^{2}} \\ = 2.036 , 36 \approx 2.040 µH\end{matrix}$$

$$\begin{matrix}{L}_{7.1} = \frac{1}{{C}_{7.1} * {( 700 π )}^{2}} \\ = \frac{{10}^{6}}{198 , 8636 * {( 700 π )}^{2}} \\ = 1.038 , 96 \approx 1.040 µH\end{matrix}$$

$$\begin{matrix}{L}_{11.2} = \frac{1}{{C}_{11.2} * {( 1100 π )}^{2}} \\ = \frac{{10}^{6}}{198 , 8636 - {( 1100 π )}^{2}} \\ = 420 , 736 \approx 420 µH\end{matrix}$$

$${x}_{A 9} = {L}_{5} * 900 π = 570 * {10}^{- 6} * 900 π = 1 , 6122857 Ω$$

$$\begin{matrix}\frac{1}{{x}_{F 9}} = \frac{1}{{L}_{5.2} * 900 π} - {C}_{5.2} * 900 π \\ = \frac{{10}^{6}}{2.040 * 900 π} - 198 , 8636 * {10}^{- 6} * 900 π\end{matrix}$$

$${x}_{F 9} = - 2 , 5693846 Ω$$

$$\begin{matrix}\frac{1}{{x}_{G 9}} = \frac{1}{{L}_{7.1} * 900 π} - {C}_{7.1} * 900 π \\ = \frac{{10}^{6}}{1.040 * 900 π} - 198 , 8636 * {10}^{- 6} * 900 π\end{matrix}$$

$${x}_{G 9} = - 4 , 4931288 Ω$$

$$\begin{matrix}\frac{1}{{x}_{H 9}} = \frac{1}{{L}_{11.2} * 900 π} - {C}_{11.2} * 900 π \\ = \frac{{10}^{6}}{420 * 900 π} - 198 , 8636 * {10}^{- 6} * 900 π\end{matrix}$$

$${x}_{H 9} = 3 , 58100847 Ω$$

$${x}_{I 9} = {L}_{9} * 900 π$$

$${x}_{( F - I ) 9} = - 2 , 5693846 - 4 , 4931288 + 3 , 58100847 + ( {L}_{9} * 900 π )$$

$${x}_{( F - I ) 9} = ( {L}_{9} * 900 π ) - 3 , 4815049$$

$$\begin{matrix}\frac{1}{{x}_{( A - I ) 9}} = \frac{1}{{x}_{A 9}} + \frac{1}{{x}_{( F - I ) 9}} \\ = \frac{1}{1 , 6122857} + \frac{1}{( {L}_{9} * 900 π ) - 3 , 4815049} \\ = \frac{( {L}_{9} * 900 π ) - 1 , 8692192}{4.560 , 4652657 {L}_{9} - 5 , 61318}\end{matrix}$$

$${x}_{( A - I ) 9} = \frac{4.560 , 4652657 {L}_{9} - 5 , 61318}{( {L}_{9} * 900 π ) - 1 , 8692192}$$

$$\begin{matrix}\frac{1}{{x}_{O 9}} = \frac{1}{{L}_{λ} * 900 π} - {C}_{λ} * 900 π \\ = \frac{{10}^{6}}{10.183 , 33 * 900 π} - 994 , 3179 * {10}^{- 6} * 900 π\end{matrix}$$

$${x}_{O 9} = - 0 , 359994 Ω$$

$${x}_{9} = \frac{{V}_{9}}{{I}_{7}^{′}}$$

$$\begin{matrix}{x}_{9} = \frac{11 , 99}{( 300 / 10 )} \\ = 0 , 39966 \\ = \frac{4.560 , 4652657 {L}_{9} - 5 , 61318}{( {L}_{9} * 900 π ) - 1 , 86921092} - 0 , 3599994\end{matrix}$$

$$0 , 7596654 = \frac{4.560 , 4652657 {L}_{9} - 5 , 61318}{( {L}_{9} * 900 π ) - 1 , 86921092}$$

$$2.148 , 7678457 {L}_{9} - 1 , 419981 = 4.560 , 4652657 {L}_{9} - 5 , 61318$$

$$2.411 , 69742 {L}_{9} = 4 , 193199$$

$${L}_{9} - 1.738 , 69 \approx 1.740 μH$$

$${I}_{11}^{′} = \frac{200}{10} = 20 A$$

Here, we calculate the power capacitor values in this circuit, because the higher value of this harmonic current will pass from A and (K-N) circuits

Q₁₁=\sqrt{3}*20*400=13.856,4 VAr

We round off this value to Q₁₁=20 kVAr.

$${C}_{5.2} = {C}_{7.1} = {C}_{9.2} = \frac{20.000}{3 * {400}^{2} * 100 π} = 132 , 57 µF$$

The calculation of the values of the power reactance inductors will be as below, because these power capacitors will be used as the 5-7-9th harmonic barrier circuits.

$$\begin{matrix}{L}_{5.3} = \frac{1}{{C}_{5.3} * {( 500 π )}^{2}} \\ = \frac{{10}^{6}}{132 , 57 * {( 500 π )}^{2}} \\ = 3.054 , 67 \approx 3.060 µH\end{matrix}$$

$$\begin{matrix}{L}_{7.2} = \frac{1}{{C}_{7.2} * {( 700 π )}^{2}} \\ = \frac{{10}^{6}}{132 , 57 * {( 700 π )}^{2}} \\ = 1.558 , 5 \approx 1.560 µH\end{matrix}$$

$$\begin{matrix}{L}_{9.2} = \frac{1}{{C}_{9.2} * {( 900 π )}^{2}} \\ = \frac{{10}^{6}}{132 , 57 * {( 900 π )}^{2}} \\ = 942 , 8 \approx 940 µH\end{matrix}$$

$${x}_{A 11} = {L}_{5} * 1100 π = 570 * {10}^{- 6} * 1100 π = 1 , 970571 Ω$$

$$\begin{matrix}\frac{1}{{x}_{K 11}} = \frac{1}{{L}_{5.3} * 1.100 π} - {C}_{5.3} * 1.100 π \\ = \frac{{10}^{6}}{3.060 * 1.100 π} - 132 , 57 * {10}^{- 6} * 1.100 π\end{matrix}$$

$${x}_{K 11} = - 2 , 748874 Ω$$

$$\begin{matrix}\frac{1}{{x}_{L 11}} = \frac{1}{{L}_{7.2} * 1.100 π} - {C}_{7.2} * 1.100 π \\ = \frac{{10}^{6}}{1.560 * 1.100 π} - 132 , 57 * {10}^{- 6} * 1.100 π\end{matrix}$$

$${x}_{L 119} = - 3 , 6644427 Ω$$

$$\begin{matrix}\frac{1}{{x}_{M 11}} = \frac{1}{{L}_{9.2} * 1.100 π} - {C}_{9.2} * 1.100 π \\ = \frac{{10}^{6}}{940 * 1.100 π} - 132 , 57 * {10}^{- 6} * 1.100 π\end{matrix}$$

$${x}_{M 11} = - 6 , 6403677 Ω$$

$${x}_{N 11} = {L}_{11} * 1.100 π$$

$${x}_{( K - N ) 11} = - 2 , 748874 - 3 , 6644427 - 6 , 6403677 + ( {L}_{11} * 1.100 π )$$

$${x}_{( K - N ) 11} = ( {L}_{11} * 1.100 π ) - 13 , 0536844$$

$$\begin{matrix}\frac{1}{{x}_{( A - N ) 11}} = \frac{1}{1 , 970571} + \frac{1}{( {L}_{11} * 1.100 π ) - 13 , 0536844} \\ = \frac{( {L}_{11} * 1.100 π ) - 11 , 0831134}{6.812 , 545457 {L}_{11} - 25 , 7232119}\end{matrix}$$

$${x}_{( A - N ) 11} = \frac{6.812 , 545457 {L}_{11} - 25 , 7232119}{( {L}_{11} * 1.100 π ) - 11 , 08311134}$$

$$\begin{matrix}\frac{1}{{x}_{O 11}} = \frac{1}{{L}_{λ} * 1.100 π} - {C}_{λ} * 1.100 π \\ = \frac{{10}^{6}}{10.183 , 33 * 1.100 π} - 994 , 3179 * {10}^{- 6} * 1.100 π\end{matrix}$$

$${x}_{O 11} = - 0 , 293333 Ω$$

$${x}_{11} = \frac{{V}_{11}}{{I}_{11}^{′}}$$

$$\begin{matrix}{x}_{11} = \frac{9 , 77}{( 200 / 10 )} \\ = 0 , 4885 \\ = \frac{6.812 , 545457 {L}_{11} - 25 , 7232119}{( {L}_{11} * 1.100 π ) - 11 , 0831134} - 0 , 293333\end{matrix}$$

$$0 , 781833 = \frac{6.812 , 545457 {L}_{11} - 25 , 7232119}{( {L}_{11} * 1.100 π ) - 11 , 0831134}$$

$$2.702 , 908371 {L}_{11} - 8 , 665143 = 6.812 , 545457 {L}_{11} - 25 , 7232119$$

$$4.109 , 637086 {L}_{11} = 17 , 0580689$$

$${L}_{11} = 4.150 , 748 \approx 4.150 µH$$

It is possible to use a solid-state relay, which has an instant reply capacity with zero transition, in the example of the harmonic absorber described above, instead of a contactor with slow reply capacity.

If the example we have given above, is investigated in detail, it will be easily understood that the current and the voltage values on the harmonic levels of the power reactance inductors are calculated as follows:

$$I \text{-} 50 Hz$$

$${x}_{A 1} = {L}_{5} * {10}^{- 6} * 100 π = 570 * {10}^{- 6} * 100 π = 0 , 1791428$$

$$\frac{1}{{x}_{B 1}} = \frac{{10}^{6}}{1530 * 100 π} - 265 , 15 * {10}^{- 6} * 100 π {x}_{B 1} = 0 , 50093 \\ \frac{1}{{x}_{C 1}} = \frac{1}{{L}_{9.1} * 100 π} - {C}_{9.1} * 100 π \\ \frac{1}{{x}_{C 1}} = \frac{{10}^{6}}{{L}_{9.1} * 100 π} - 265 , 15 * {10}^{- 6} * 100 π {x}_{C 1} = 0 , 149555 \\ \frac{1}{{x}_{D 1}} = \frac{1}{{L}_{11.1} * 100 π} - {C}_{11.1} * 100 π \\ \frac{1}{{x}_{D 1}} = \frac{{10}^{6}}{320 * 100 π} - 265 , 15 * {10}^{- 6} * 100 π {x}_{D 1} = 0 , 101421 \\ {x}_{E 1} = {L}_{7} * 100 π = 790 * {10}^{- 6} * 100 π = 0 , 248285 \\ {x}_{( B - E ) 1} = 1 , 000191$$

$$\frac{1}{{x}_{F 1}} = \frac{1}{{L}_{5.2} * 100 π} - {C}_{5.2} * 100 π$$

$$\begin{matrix}\frac{1}{{x}_{F 1}} = \frac{{10}^{6}}{2040 * 100 π} - 198 , 8636 * {10}^{- 6} * 100 π {x}_{F 1} \\ = 0 , 6679068\end{matrix}$$

$$\frac{1}{{x}_{G 1}} = \frac{1}{{L}_{7.1} * 100 π} - {C}_{7.1} * 100 π$$

$$\begin{matrix}\frac{1}{{x}_{G 1}} = \frac{{10}^{6}}{1040 * 100 π} - 198 , 8636 * {10}^{- 6} * 100 π {x}_{G 1} \\ = 0 , 3836736\end{matrix}$$

$$\frac{1}{{x}_{H 1}} = \frac{1}{{L}_{11.2} * 100 π} - {C}_{11.2} * 100 π$$

$$\begin{matrix}\frac{1}{{x}_{H 1}} = \frac{{10}^{6}}{420 * 100 π} - 198 , 8636 * {10}^{- 6} * 100 π {x}_{H 1} \\ = 0 , 133098\end{matrix}$$

$${x}_{I 1} = {L}_{9} * 100 π = 1740 * {10}^{- 6} * 100 π = 0 , 546857$$

$${x}_{( F - I ) 1} = 1 , 681535$$

$$\frac{1}{{x}_{K 1}} = \frac{1}{{L}_{5.3} * 100 π} - {C}_{5.3} * 100 π$$

$$\frac{1}{{x}_{K 1}} = \frac{{10}^{6}}{3060 * 100 π} - 132 , 57 * {10}^{- 6} * 100 π {x}_{K 1} = 1 , 001858 \\ \frac{1}{{x}_{L 1}} = \frac{1}{{L}_{7.2} * 100 π} - {C}_{7.2} * 100 π \\ \frac{1}{{x}_{L 1}} = \frac{{10}^{6}}{1560 * 100 π} - 132 , 57 * {10}^{- 6} * 100 π {x}_{L 1} = 0 , 5005099 \\ \frac{1}{{x}_{M 1}} = \frac{{10}^{6}}{{L}_{9.2} * 100 π} - {C}_{9.2} * 100 π \\ \frac{1}{{x}_{M 1}} = \frac{{10}^{6}}{940 * 100 π} - 132 , 57 * {10}^{- 6} * 100 π {x}_{M 1} = 0 , 2991103 \\ {x}_{N 1} = {L}_{11} * 00 π = 4150 * {10}^{- 6} * 100 π = 1 , 3042857 \\ {x}_{( K - N ) 1} = 3 , 1057639 \\ \frac{1}{{x}_{( A - N ) 1}} = \frac{1}{{x}_{A 1}} + \frac{1}{{x}_{( B - E ) 1}} + \frac{1}{{x}_{( F - I ) 1}} + \frac{1}{{x}_{( K - N ) 1}}$$

$$\frac{1}{{x}_{( A - N ) 1}} = \frac{1}{0 , 1791428} + \frac{1}{1 , 000191} + \frac{1}{1 , 681535} + \frac{1}{3 , 1057639}$$

$${x}_{( A - N ) 1} = 0 , 1333577$$

$$\frac{1}{{x}_{O 1}} = \frac{1}{{L}_{λ} * 100 π} - {C}_{λ} * 100 π$$

$$\frac{1}{{x}_{O 1}} = \frac{{10}^{6}}{10.183 , 33 * 100 π} - 994 , \\ 3179 * {10}^{- 6} * 100 π \to {x}_{O 1} = - 21.595 , 8422095$$

$$\begin{matrix}{x}_{1} = {x}_{( A - N ) 1} + {x}_{O 1} \\ = 0 , 1333577 - 21.595 , 8422095 \\ = - 21.595 , 7088518\end{matrix}$$

$${I}_{1} = \frac{{V}_{1}}{{x}_{1}}$$

$${V}_{1} = \frac{400}{\sqrt{3}} = 230 , 9401076$$

$${I}_{1} = \frac{230 , 9401076}{- 21.595 , 7088518} = - 0 , 01069379 A$$

$$\begin{matrix}{V}_{1} = {V}_{A 1} + {V}_{O 1} \\ = {V}_{B 1} + {V}_{C 1} + {V}_{D 1} + {V}_{E 1} + {V}_{O 1} \\ = {V}_{F 1} + {V}_{G 1} + {V}_{H 1} + {V}_{I 1} + {V}_{O 1} \\ = {V}_{K 1} + {V}_{L 1} + {V}_{M 1} + {V}_{N 1} + {V}_{O 1}\end{matrix}$$

$$\begin{matrix}{V}_{O 1} = {I}_{1} * {x}_{O 1} \\ = - 0 , 01069379 * - 21.595 , 8422095 \\ = 230 , 941401\end{matrix}$$

$$\begin{matrix}{V}_{A 1} = {V}_{1} - {V}_{O 1} \\ = 230 , 9401076 - 230 , 941401 \\ = - 0 , 0012934\end{matrix}$$

$$\begin{matrix}{I}_{A 1} = \frac{{V}_{A 1}}{{x}_{A 1}} \\ = \frac{- 0 , 0012934}{0 , 1791428} \\ = - 0 , 0072199 A\end{matrix}$$

$$( The current passing on {L}_{5} at 50 Hz )$$

$$\begin{matrix}{I}_{( B - E ) 1} = \frac{{V}_{A 1}}{{x}_{( B - E ) 1}} \\ = \frac{- 0 , 0012934}{1 , 000191} \\ = - 0 , 001293 A\end{matrix}$$

$$( The current passing on {L}_{7} at 50 Hz )$$

$$\begin{matrix}{V}_{B 1} = {I}_{( B - E ) 1} * {x}_{B 1} \\ = - 0 , 01293 * 0 , 50093 \\ = - 0 , 0006477 V\end{matrix}$$

$$\begin{matrix}{I}_{B 1.1} = \frac{{V}_{B 1}}{{L}_{5.1} * 100 π} \\ = \frac{- 0 , 0006477 * {10}^{6}}{1560 * 100 π} \\ = - 0 , 001321 A\end{matrix}$$

$$( The current passing on {L}_{5.1} at 50 Hz )$$

$$\begin{matrix}{I}_{B 2.1} = {V}_{B 1} * {C}_{5.1} * 100 π \\ = - 0 , 0006477 * - 265 , 15 * {10}^{- 6} * 100 π \\ = 0 , 0000539 A\end{matrix}$$

$$( The current passing on {C}_{5.1} at 50 Hz )$$

$$\begin{matrix}{V}_{C 1} = {I}_{( B - E ) 1} * {x}_{C 1} \\ = - 0 , 001293 * 0 , 149555 \\ = - 0 , 000193 V\end{matrix}$$

$$\begin{matrix}{I}_{C 1.1} = \frac{{V}_{C 1}}{{L}_{9.1} * 100 π} \\ = \frac{- 0 , 000193 * {10}^{6}}{470 * 100 π} \\ = - 0 , 001309 A\end{matrix}$$

$$( The current passing on {L}_{9.1} at 50 Hz )$$

$$\begin{matrix}{I}_{C 2.1} = {V}_{C 1} * {C}_{9.1} * 100 π \\ = - 0 , 0006477 * - 265 , 15 * {10}^{- 6} * 100 π \\ = 0 , 000016 A\end{matrix}$$

$$( The current passing on {C}_{9.1} at 50 Hz )$$

$$\begin{matrix}{V}_{D 1} = {I}_{( B - E ) 1} * {x}_{D 1} \\ = - 0 , 001293 * 0 , 101421 \\ = - 0 , 000131 V\end{matrix}$$

$$\begin{matrix}{I}_{D 1.1} = \frac{{V}_{D 1}}{{L}_{11.1} * 100 π} \\ = \frac{- 0 , 000131 * {10}^{6}}{320 * 100 π} \\ = - 0 , 0013 A\end{matrix}$$

$$( The current passing on {L}_{11.1} at 50 Hz )$$

$$\begin{matrix}{I}_{D 2.1} = {V}_{D 1} * {C}_{11.1} * 100 π \\ = - 0 , 000131 * - 265 , 15 * {10}^{- 6} * 100 π \\ = 0 , 0000109 A\end{matrix}$$

$$( The current passing on {C}_{11.1} at 50 Hz )$$

$$\begin{matrix}{V}_{E 1} = {I}_{( B - E )} * {x}_{E 1} \\ = - 0 , 001293 * 0 , 248285 \\ = - 0 , 000321 V\end{matrix}$$

$$\begin{matrix}{I}_{( F - I ) 1} = \frac{{V}_{A 1}}{{x}_{( F - I ) 1}} \\ = \frac{- 0 , 0012934}{1 , 681535} \\ = - 0 , 000769 A\end{matrix}$$

$$( The current passing on {L}_{9} at 50 Hz )$$

$$\begin{matrix}{V}_{F 1} = {I}_{( F - I ) 1} * {x}_{F 1} \\ = - 0 , 000769 * 0 , 6679068 \\ = - 0 , 0005136 V\end{matrix}$$

$$\begin{matrix}{I}_{F 1.1} = \frac{{V}_{F 1}}{{L}_{5.2} * 100 π} \\ = \frac{- 0 , 0005136 * {10}^{6}}{2040 * 100 π} \\ = - 0 , 000801 A\end{matrix}$$

$$( The current passing on {L}_{5.2} at 50 Hz )$$

$$\begin{matrix}{I}_{F 2.1} = {V}_{F 1} * {C}_{5.2} * 100 π \\ = - 0 , 0005136 * - 198 , 8636 * {10}^{- 6} * 100 π \\ = 0 , 00032 A\end{matrix}$$

$$( The current passing on {C}_{5.2} at 50 Hz )$$

$$\begin{matrix}{V}_{G 1} = {I}_{( F - I ) 1} * {x}_{G 1} \\ = - 0 , 0005136 * 0 , 3336736 \\ = - 0 , 000171 V\end{matrix}$$

$$\begin{matrix}{I}_{G 1.1} = \frac{{V}_{G 1}}{{L}_{7.1} * 100 π} \\ = \frac{- 0 , 000171 * {10}^{6}}{1040 * 100 π} \\ = - 0 , 000523 A\end{matrix}$$

$$( The current passing on {L}_{7.1} at 50 Hz )$$

$$\begin{matrix}{I}_{G 2.1} = {V}_{G 1} * {C}_{7.1} * 100 π \\ = - 0 , 000171 * - 198 , 8636 * {10}^{- 6} * 100 π \\ = 0 , 00001 A\end{matrix}$$

$$( The current passing on {C}_{7.1} at 50 Hz )$$

$$\begin{matrix}{V}_{H 1} = {I}_{( F - I ) 1} * {x}_{H 1} \\ = - 0 , 0005136 * 0 , 133098 \\ = - 0 , 000068 V\end{matrix}$$

$$\begin{matrix}{I}_{H 1.1} = \frac{{V}_{H 1}}{{L}_{11.2} * 100 π} \frac{- 0 , 000068 * {10}^{6} }{420 * 100 π} \\ = - 0 , 000515 A\end{matrix}$$

$$( The current passing on {L}_{11.2} at 50 Hz )$$

$$\begin{matrix}{I}_{H 2.1} = {V}_{H 1} * {C}_{11.2} * 100 π \\ = - 0 , 000068 * - 198 , 8636 * {10}^{- 6} * 100 π \\ = 0 , 000004 A\end{matrix}$$

$$( The current passing on {C}_{11.2} at 50 Hz )$$

$$\begin{matrix}{V}_{I .1} = {I}_{( F - I ) 1} * {x}_{1} \\ = - 0 , 0005136 * 0 , 546857 \\ = - 0 , 00028 V\end{matrix}$$

$$\begin{matrix}{I}_{( K - N ) 1} = \frac{{V}_{A 1}}{{x}_{( K - N ) 1}} \\ = \frac{- 0 , 00028}{- 3 , 1057639} \\ = - 0 , 00009 A\end{matrix}$$

$$( The current passing on {L}_{11} at 50 Hz )$$

$${V}_{K 1} = {I}_{( K - N ) 1} * {x}_{K 1} = - 0 , 00009 * 1 , 001858 = 0 , 00009 V$$

$$\begin{matrix}{I}_{K 1.1} = \frac{{V}_{K 1}}{{L}_{5.3} * 100 π} \\ = \frac{- 0 , 00009 * {10}^{6}}{3060 * 100 π} \\ = - 0 , 000093 A\end{matrix}$$

$$( The current passing on {L}_{5.3} at 50 Hz )$$

$$\begin{matrix}{I}_{K 2.1} = {V}_{K 1} * {C}_{5.3} * 100 π \\ = - 0 , 00009 * - 132 , 57 * {10}^{- 6} * 100 π \\ = 0 , 0000037 A\end{matrix}$$

$$( The current passing on {C}_{5.3} at 50 Hz )$$

$${V}_{L 1} = {I}_{( K - N ) 1} * {x}_{L 1} = - 0 , 00009 * 0 , 5005099 = - 0 , 000045 V$$

$$\begin{matrix}{I}_{L 1.1} = \frac{{V}_{L 1}}{{L}_{7.2} * 100 π} \\ = \frac{- 0 , 000045 * {10}^{6}}{1560 * 100 π} \\ = - 0 , 000091 A\end{matrix}$$

$$( The current passing on {L}_{7.2} at 50 Hz )$$

$$\begin{matrix}{I}_{L 2.1} = {V}_{L 1} * {C}_{7.2} * 100 π \\ = - 0 , 000045 * - 132 , 57 * {10}^{- 6} * 100 π \\ = 0 , 0000018 A\end{matrix}$$

$$( The current passing on {C}_{7.2} at 50 Hz )$$

$${V}_{M 1} = {I}_{( K - N ) 1} * {x}_{M 1} = - 0 , 000045 * 0 , 2991103 = - 0 , 0000269 V$$

$$\begin{matrix}{I}_{M 1.1} = \frac{{V}_{M 1}}{{L}_{9.2} * 100 π} \\ = \frac{- 0 , 0000269 * {10}^{6}}{940 * 100 π} \\ = - 0 , 000091 A\end{matrix}$$

$$( The current passing on {L}_{9.2} at 50 Hz )$$

$$\begin{matrix}{I}_{M 2.1} = {V}_{M 1} * {C}_{9.2} * 100 π \\ = - 0 , 0000269 * - 132 , 57 * {10}^{- 6} * 100 π \\ = 0 , 000807 A\end{matrix}$$

$$( The current passing on {C}_{9.2} at 50 Hz )$$

$${V}_{N 1} = {I}_{( K - N ) 1} * {x}_{N 1} = - 0 , 00009 * 1 , 3042857 = - 0 , 000117 V$$

$${V}_{O 1} = 230 , 941401 V idi . {U}_{O 1} = \sqrt{3} * {V}_{O 1} = 400 , 00224 V$$

$$\begin{matrix}{I}_{L Δ 1} = \frac{{U}_{O 1}}{{L}_{Δ} * 100 π} \\ = \frac{400 , 00224 * {10}^{6}}{30550 * 100 π} \\ = 41 , 6607 A\end{matrix}$$

$$( The current passing on {L}_{Δ} at 50 Hz )$$

$$\begin{matrix}{I}_{C Δ 1} = {U}_{O 1} * {C}_{Δ 1} * 100 π \\ = 400 , 00224 * - 331 , 4393 * {10}^{- 6} * 100 π \\ = - 41 , 666888 A\end{matrix}$$

$$( The current passing on {C}_{Δ} at 50 Hz )$$

$$II \text{-} 250 Hz$$

$${x}_{A 5} = 570 * {10}^{- 6} * 500 π = 0 , 895714$$

$$\frac{1}{{x}_{B 5}} = \frac{{10}^{6}}{1530 * 500 π} - 265 , 15 * {10}^{- 6} * 500 π {x}_{B 5} = - 1.878 , 363188$$

$$\frac{1}{{x}_{C 5}} = \frac{{10}^{6}}{470 * 500 π} - 256 , 15 * {10}^{- 6} * 500 π {x}_{C 5} = 1 , 066893$$

$$\frac{1}{{x}_{D 5}} = \frac{{10}^{6}}{320 * 500 π} - 265 , 15 * {10}^{- 6} * 500 π {x}_{D 5} = 0 , 636143$$

$${x}_{E 5} = 790 * {10}^{- 6} * 500 π = 1 , 241428$$

$${x}_{( B - E ) 5} = - 1.875 , 418724$$

$$\begin{matrix}\frac{1}{{x}_{F 5}} = \frac{{10}^{6}}{2040 * 500 π} - 198 , 8636 * {10}^{- 6} * 500 π {x}_{F 5} \\ = - 1.795 , 384175\end{matrix}$$

$$\frac{1}{{x}_{G 5}} = \frac{{10}^{6}}{1040 * 500 π} - 198 , 8636 * {10}^{- 6} * 500 π {x}_{G 5} = 3 , 340145$$

$$\frac{1}{{x}_{H 5}} = \frac{{10}^{6}}{420 * 500 π} - 198 , 8636 * {10}^{- 6} * 500 π {x}_{H 5} = 0 , 831496$$

$${x}_{I 5} = 1740 * {10}^{- 6} * 500 π = 2 , 734285$$

$${x}_{( F - I ) 5} = - 1.788 , 478249$$

$$\begin{matrix}\frac{1}{{x}_{K 5}} = \frac{{10}^{6}}{3060 * 500 π} - 132 , 57 * {10}^{- 6} * 500 π {x}_{K 5} \\ = - 2.760 , 044138\end{matrix}$$

$$\frac{1}{{x}_{L 5}} = \frac{{10}^{6}}{1560 * 500 π} - 132 , 57 * {10}^{- 6} * 500 π {x}_{L 5} = 5 , 009991$$

$$\frac{1}{{x}_{M 5}} = \frac{{10}^{6}}{940 * 500 π} - 132 , 57 * {10}^{- 6} * 500 π {x}_{M 5} = 2 , 13375$$

$${x}_{N 5} = 4150 * {10}^{- 6} * 500 π = 6 , 521428$$

$${x}_{( K - N ) 5} = - 2.746 , 378969$$

$$\begin{matrix}\frac{1}{{x}_{O 5}} = \frac{{10}^{6}}{10.183 , 33 * 500 π} - 994 , 3179 * {10}^{- 6} * 500 π {x}_{O 5} \\ = - 0 , 666662\end{matrix}$$

$$\frac{1}{{x}_{( A - N ) 5}} = \frac{1}{0 , 895714} + \frac{1}{1.875 , 418724} - \frac{1}{1.788 , 478249} - \frac{1}{2.746 , 378969}$$

$${x}_{( A - N ) 5} = 0 , 896884$$

$${x}_{5} = 0 , 896884 - 0 , 666662 = 0 , 230222$$

$${I}_{5} = \frac{8 , 88}{0 , 230222} = 38 , 5714658 A$$

$$\begin{matrix}{V}_{5} = {V}_{A 5} + {V}_{O 5} \\ = {V}_{B 5} + {V}_{C 5} + {V}_{D 5} + {V}_{E 5} + {V}_{O 5} \\ = {V}_{F 5} + {V}_{G 5} + {V}_{H 5} + {V}_{I 5} + {V}_{O 5} \\ = {V}_{K 5} + {V}_{L 5} + {V}_{M 5} + {V}_{N 5} + {V}_{O 5}\end{matrix}$$

$$\begin{matrix}{I}_{A 5} = \frac{34 , 59413}{0 , 895714} \\ = 38 , 621848 A \\ ( The current passing on {L}_{5} at 250 Hz )\end{matrix}$$

$$\begin{matrix}{I}_{( B - E ) 5} = \frac{34 , 59413}{- 1.875 , 418724} \\ = - 0 , 018446 A \\ ( The current passing on {L}_{7} at 250 Hz )\end{matrix}$$

$${V}_{B 5} = - 0 , 018446 * - 1.878 , 363188 = 34 , 648287 V$$

$$\begin{matrix}{I}_{B 1.5} = \frac{34 , 648287 * {10}^{6}}{1560 * 500 π} \\ = 14 , 133916 A \\ ( The current passing on {L}_{5.1} at 250 Hz )\end{matrix}$$

$$\begin{matrix}{I}_{B 2.5} = 34 , 648287 * - 265 , 15 * {10}^{- 6} * 500 π \\ = - 14 , 436703 A \\ ( The current passing on {C}_{5.1} at 250 Hz )\end{matrix}$$

$${V}_{C 5} = - 0 , 018446 * 1 , 066893 = - 0 , 0196799 V$$

$$\begin{matrix}{I}_{C 1.5} = \frac{- 0 , 0196799 * {10}^{6}}{470 * 500 π} \\ = - 0 , 0266458 A \\ ( The current passing on {L}_{9.1} at 250 Hz )\end{matrix}$$

$$\begin{matrix}{I}_{C 2.5} = - 0 , 0196799 * - 265 , 15 * {10}^{- 6} * 500 π \\ = 0 , 008199 A \\ ( The current passing on {C}_{9.1} at 250 Hz )\end{matrix}$$

$${V}_{D 5} = - 0 , 018466 * 0 , 636143 = - 0 , 011734 V$$

$$\begin{matrix}{I}_{D 1.5} = \frac{- 0 , 011734 * {10}^{6}}{320 * 500 π} \\ = - 0 , 023334 A \\ ( The current passing on {L}_{11.1} at 250 Hz )\end{matrix}$$

$$\begin{matrix}{I}_{D 2.5} = - 0 , 011734 * - 265 , 15 * {10}^{- 6} * 500 π \\ = 0 , 004889 A \\ ( The current passing on {C}_{11.1} at 250 hz )\end{matrix}$$

$${V}_{E 5} = - 0 , 018446 * 1 , 241428 = - 0 , 022899 V$$

$$\begin{matrix}{I}_{( F - I ) 5} = \frac{34 , 59413}{- 1.788 , 478249} \\ = - 0 , 019342 A \\ ( The current passing on {L}_{9} at 250 Hz )\end{matrix}$$

$${V}_{F 5} = - 0 , 019342 * - 1.795 , 384175 = 34 , 72632 V$$

$$\begin{matrix}{I}_{F 1.5} = \frac{34 , 72632 * {10}^{6}}{2040 * 500 π} \\ = 10 , 832631 A \\ ( The current passing on {L}_{5.2} at 250 Hz )\end{matrix}$$

$$\begin{matrix}{I}_{F 2.5} = 34 , 72632 * - 198 , 8636 * {10}^{- 6} * 500 π \\ = - 10 , 851973 A \\ ( The current passing on {C}_{5.2} at 250 Hz )\end{matrix}$$

$${V}_{G 5} = - 0 , 019342 * 3 , 340145 = - 0 , 064605 V$$

$$\begin{matrix}{I}_{G 1.5} = \frac{- 0 , 064605 * {10}^{6}}{1040 * 500 π} \\ = - 0 , 039531 A \\ ( The current passing on {L}_{7.1} at 250 Hz )\end{matrix}$$

$$\begin{matrix}{I}_{G 2.5} = - 0 , 064605 * - 198 , 8636 * {10}^{- 6} * 500 π \\ = 0 , 020189 A \\ ( The current passing on {C}_{7.1} at 250 Hz )\end{matrix}$$

$${V}_{H 5} = - 0 , 019342 * 0 , 831496 = - 0 , 016082 V$$

$$\begin{matrix}{I}_{H 1.5} = \frac{- 0 , 016082 * {10}^{6}}{420 * 500 π} \\ = - 0 , 024366 A \\ ( The current passing on {L}_{11.2} at 250 Hz )\end{matrix}$$

$$\begin{matrix}{I}_{H 2.5} = - 0 , 016082 * - 198 , 8636 * {10}^{- 6} * 500 π \\ = 0 , 005025 A \\ ( The current passing on {C}_{11.2} at 250 Hz )\end{matrix}$$

$${V}_{I .5} = - 0 , 019342 * 2 , 734285 = - 0 , 052886 V$$

$$\begin{matrix}{I}_{( K - N ) 5} = \frac{34 , 59413}{- 276 , 378969} \\ = - 0 , 012596 A \\ ( The current passing on {L}_{11} at 250 Hz )\end{matrix}$$

$${V}_{K 5} = - 0 , 012596 * - 2760 , 044138 = 34 , 765515 V$$

$$\begin{matrix}{I}_{K 1.5} = \frac{34 , 765515 * {10}^{6}}{3060 * 500 π} \\ = 7 , 229905 A \\ ( The current passing on {L}_{5.3} at 250 Hz )\end{matrix}$$

$$\begin{matrix}{I}_{K 2.5} = 34 , 765515 * - 132 , 57 * {10}^{- 6} * 500 π \\ = - 7 , 242501 A \\ ( The current passing on {C}_{5.3} at 250 Hz )\end{matrix}$$

$${V}_{L 5} = - 0 , 012596 * 5 , 009991 = - 0 , 631058 V$$

$$\begin{matrix}{I}_{L 1.5} = \frac{- 0 , 631058 * {10}^{6}}{1560 * 500 π} \\ = - 0 , 257424 A \\ ( The current passing on {L}_{7.2} at 250 Hz )\end{matrix}$$

$$\begin{matrix}{I}_{L 2.5} = - 0 , 631058 * - 132 , 57 * {10}^{- 6} * 500 π \\ = 0 , 131473 A \\ ( The current passing on {C}_{7.2} at 250 Hz )\end{matrix}$$

$${V}_{M 5} = - 0 , 012596 * 2 , 13375 = - 0 , 026876 V$$

$$\begin{matrix}{I}_{M 1.5} = \frac{- 0 , 026876 * {10}^{6}}{940 * 500 π} \\ = - 0 , 018194 A \\ ( The current passing on {L}_{9.2} at 250 Hz )\end{matrix}$$

$$\begin{matrix}{I}_{M 2.5} = - 0 , 026876 * - 132 , 57 * {10}^{- 6} * 500 π \\ = 0 , 005598 A \\ ( The current passing on {C}_{9.2} at 250 Hz )\end{matrix}$$

$${V}_{N 5} = - 0 , 012596 * 6 , 521428 = - 0 , 0821439 V$$

$${V}_{O 5} = - 25 , 71413 V idi . {U}_{O 5} = - 44 , 538179 V$$

$$\begin{matrix}{I}_{L Δ 5} = \frac{- 44 , 538179 * {10}^{6}}{30550 * 500 π} \\ = - 0 , 92774 A \\ ( The current passing on {L}_{Δ} at 250 Hz )\end{matrix}$$

$$\begin{matrix}{I}_{C Δ 5} = - 44 , 538179 * - 331 , 4393 * {10}^{- 6} * 500 π \\ = 23 , 196961 A \\ ( The current passing on {C}_{Δ} at 250 Hz )\end{matrix}$$

$$III \text{-} 350 Hz$$

$${x}_{A 7} = 570 * {10}^{- 6} * 700 π = 1 , 254$$

$$\frac{1}{{x}_{B 7}} = \frac{{10}^{6}}{1530 * 700 π} - 265 , 15 * {10}^{- 6} * 700 π {x}_{B 7} = - 3 , 493553$$

$$\frac{1}{{x}_{C 7}} = \frac{{10}^{6}}{470 * 700 π} = - 256 , 15 * {10}^{- 6} * 700 π {x}_{C 7} = 2 , 605605$$

$$\frac{1}{{x}_{D 7}} = \frac{{10}^{6}}{320 * 700 π} - 265 , 15 * {10}^{- 6} * 700 π {x}_{D 7} = 1 , 194565$$

$${x}_{E 7} = 790 * {10}^{- 6} * 700 π = 1 , 738$$

$${x}_{( B - E ) 7} = 2 , 044617$$

$$\begin{matrix}\frac{1}{{x}_{F 7}} = \frac{{10}^{6}}{2040 * 700 π} - 198 , 8636 * {10}^{- 6} * 700 π {x}_{F 7} \\ = - 4 , 658019\end{matrix}$$

$$\begin{matrix}\frac{1}{{x}_{G 7}} = \frac{{10}^{6}}{1040 * 700 π} - 198 , 8636 * {10}^{- 6} * 700 π {x}_{G 7} \\ = - 2.288 , 4188719\end{matrix}$$

$$\begin{matrix}\frac{1}{{x}_{H 7}} = \frac{{10}^{6}}{420 * 700 π} - 198 , 8636 * {10}^{- 6} * 700 π {x}_{H 7} \\ = 1 , 550985\end{matrix}$$

$${x}_{I 7} = 1740 * {10}^{- 6} * 700 π = 3 , 828$$

$${x}_{( F - I ) 7} = - 2.287 , 6979059$$

$$\frac{1}{{x}_{K 7}} = \frac{{10}^{6}}{3060 * 700 π} - 132 , 57 * {10}^{- 6} * 700 π {x}_{K 7} = - 6 , 987644$$

$$\begin{matrix}\frac{1}{{x}_{L 7}} = \frac{{10}^{6}}{1560 * 700 π} - 132 , 57 * {10}^{- 6} * 700 π {x}_{L 7} \\ = - 3587 , 976513\end{matrix}$$

$$\begin{matrix}\frac{1}{{x}_{M 7}} = \frac{{10}^{6}}{940 * 700 π} - 132 , 57 * {10}^{- 6} * 700 π {x}_{M 7} \\ = 5 , 2109118\end{matrix}$$

$${x}_{N 7} = 4150 * {10}^{- 6} * 700 π = 9 , 13$$

$${x}_{( K - N ) 7} = - 3580 , 623245$$

$$\begin{matrix}\frac{1}{{x}_{O 7}} = \frac{{10}^{6}}{10.183 , 33 * 700 π} - 994 , 3179 * {10}^{- 6} * 700 π {x}_{O 7} \\ = - 0 , 466665\end{matrix}$$

$$\frac{1}{{x}_{( A - N ) 7}} = \frac{1}{1 , 254} + \frac{1}{2 , 044617} - \frac{1}{2.287 , 6979059} - \frac{1}{3.580 , 623245}$$

$${x}_{( A - N ) 7} = 0 , 777713$$

$${x}_{7} = 0 , 777713 - 0 , 466665 = 0 , 311048$$

$${I}_{7} = \frac{15 , 55}{0 , 311048} = 49 , 992284 A$$

$$\begin{matrix}{V}_{7} = {V}_{A 7} + {V}_{O 7} \\ = {V}_{B 7} + {V}_{C 7} + {V}_{D 7} + {V}_{E 7} + {V}_{O 7} \\ = {V}_{F 7} + {V}_{G 7} + {V}_{H 7} + {V}_{I 7} + {V}_{O 7} \\ = {V}_{K 7} + {V}_{L 7} + {V}_{M 7} + {V}_{N 7} + {V}_{O 7}\end{matrix}$$

$$\begin{matrix}{I}_{A7} = \frac{38 , 879649}{1 , 254} \\ = 31 , 004504 A \\ ( The current passing on {L}_{5} at 350 Hz )\end{matrix}$$

$$\begin{matrix}{I}_{( B - E ) 7} = \frac{38 , 879649}{2 , 044617} \\ = 19 , 015614 A \\ ( The current passing on {L}_{7} at 350 Hz )\end{matrix}$$

$${V}_{B 7} = 19 , 015614 * - 3 , 493553 = - 66 , 432055 V$$

$$\begin{matrix}{I}_{B 1.7} = \frac{- 66 , 432055 * {10}^{6}}{1560 * 700 π} \\ = - 19 , 356659 A \\ ( The current passing on {L}_{5.1} at 350 Hz )\end{matrix}$$

$$\begin{matrix}{I}_{B 2.7} = - 66 , 432055 * - 265 , 15 * {10}^{- 6} * 700 π \\ = 38 , 75181 A \\ ( The current passing on {C}_{5.1} at 350 Hz )\end{matrix}$$

$${V}_{C 7} = 19 , 015614 * 2 , 605605 = 50 , 506421 V$$

$$\begin{matrix}{I}_{C 1.7} = \frac{50 , 506421 * {10}^{6}}{470 * 700 π} \\ = 48 , 845668 A \\ ( The current passing on {L}_{9.1} at 350 Hz )\end{matrix}$$

$$\begin{matrix}{I}_{C 2.7} = 50 , 506421 * - 265 , 15 * {10}^{- 6} * 700 π \\ = - 29 , 46191 A \\ ( The current passing on {C}_{9.1} at 350 Hz )\end{matrix}$$

$${V}_{D 7} = 19 , 015614 * 1 , 194565 = 22 , 715386 V$$

$$\begin{matrix}{I}_{D 1.7} = \frac{22 , 715386 * {10}^{6}}{320 * 700 π} \\ = 32 , 266173 A \\ ( The current passing on {L}_{11.1} at 350 Hz )\end{matrix}$$

$$\begin{matrix}{I}_{D 2.7} = 22 , 715386 * - 265 , 15 * {10}^{- 6} * 700 π \\ = - 13 , 250566 A \\ ( The current passing on {C}_{11.1} at 350 Hz )\end{matrix}$$

$${V}_{E 7} = 19 , 015614 * 1 , 738 = 33 , 049137 V$$

$$\begin{matrix}{I}_{( F - I ) 7} = \frac{38 , 879649}{- 2.287 , 6979059} \\ = - 0 , 016995 A \\ ( The current passing on {L}_{9} at 350 Hz )\end{matrix}$$

$${V}_{F 7} = - 0 , 016995 * - 4 , 658019 = 0 , 079463 V$$

$$\begin{matrix}{I}_{F 1.7} = \frac{0 , 079463 * {10}^{6}}{2040 * 700 π} \\ = 0 , 017638 A \\ ( The current passing on {L}_{5.2} at 350 Hz )\end{matrix}$$

$$\begin{matrix}{I}_{F 2.7} = 0 , 079163 * - 198 , 8636 * {10}^{- 6} * 700 π \\ = - 0 , 034633 A \\ ( The current passing on {C}_{5.2} at 350 Hz )\end{matrix}$$

$${V}_{G 7} = - 0 , 016995 * - 2.288 , 4188719 = 38 , 891678 V$$

$$\begin{matrix}{I}_{G 1.7} = \frac{38 , 891678 * {10}^{6}}{1040 * 700 π} \\ = 16 , 998111 A \\ ( The current passing on {L}_{7.1} at 350 Hz )\end{matrix}$$

$$\begin{matrix}{I}_{G 2.7} = 38 , 891678 * - 198 , 8636 * {10}^{- 6} * 700 π \\ = - 17 , 01506 A \\ ( The current passing on {C}_{7.1} at 350 Hz )\end{matrix}$$

$${V}_{H 7} = - 0 , 016995 * 1 , 550985 = - 0 , 026358 V$$

$$\begin{matrix}{I}_{H 1.7} = \frac{- 0 , 026358 * {10}^{6}}{420 * 700 π} \\ = - 0 , 0285259 A \\ ( The current passing on {L}_{11.2} at 350 Hz )\end{matrix}$$

$$\begin{matrix}{I}_{H 2.7} = - 0 , 026358 * - 198 , 8636 * {10}^{- 6} * 700 π \\ = 0 , 011531 A \\ ( The current passing on {C}_{11.2} at 350 Hz )\end{matrix}$$

$${V}_{I .7} = - 0 , 016995 * 3 , 828 = - 0 , 065056 V$$

$$\begin{matrix}{I}_{( K - N ) 7} = \frac{38 , 879649}{- 3.580 , 623245} \\ = - 0 , 010858 A \\ ( The current passing on {L}_{11} at 350 Hz )\end{matrix}$$

$${V}_{K 7} = - 0 , 010858 * - 6 , 987644 = 0 , 075871 V$$

$$\begin{matrix}{I}_{K 1.7} = \frac{0 , 075871 * {10}^{6}}{3060 * 700 π} \\ = 0 , 01127 A \\ ( The current passing on {L}_{5.3} at 350 Hz )\end{matrix}$$

$$\begin{matrix}{I}_{K 2.7} = 0 , 075871 * - 132 , 57 * {10}^{- 6} * 700 π \\ = - 0 , 022128 A \\ ( The current passing on {C}_{5.3} at 350 Hz )\end{matrix}$$

$${V}_{L 7} = - 0 , 010858 * 3.587 , 976513 = 38 , 958248 V$$

$$\begin{matrix}{I}_{L 1.7} = \frac{38 , 958248 * {10}^{6}}{1560 * 700 π} \\ = 11 , 35147 A \\ ( The current passing on {L}_{7.2} at 350 Hz )\end{matrix}$$

$$\begin{matrix}{I}_{L 2.7} = 38 , 958248 * - 132 , 57 * {10}^{- 6} * 700 π \\ = - 11 , 362328 A \\ ( The current passing on {C}_{7.2} at 350 Hz )\end{matrix}$$

$${V}_{M 7} = - 0 , 010858 * 5 , 2109118 = - 0 , 05658 V$$

$$\begin{matrix}{I}_{M 1.7} = \frac{- 0 , 05658 * {10}^{6}}{940 * 700 π} \\ = - 0 , 027359 A \\ ( The current passing on {L}_{9.2} at 350 Hz )\end{matrix}$$

$$\begin{matrix}{I}_{M 2.7} = - 0 , 05658 * - 132 , 57 * {10}^{- 6} * 700 π \\ = 0 , 0165017 A \\ ( The current passing on {C}_{9.2} at 350 Hz )\end{matrix}$$

$${V}_{N 7} = - 0 , 010858 * 9 , 13 = - 0 , 099133 V$$

$${V}_{O 7} = - 23 , 329649 V idi . {U}_{O 7} = - 40 , 408137 V$$

$$\begin{matrix}{I}_{L Δ 7} = \frac{- 40 , 408137 * {10}^{6}}{30550 * 700 π} \\ = - 0 , 601222 A \\ ( The current passing on {L}_{Δ} at 350 Hz )\end{matrix}$$

$$\begin{matrix}{I}_{C Δ 7} = - 40 , 408137 * - 331 , 4393 * {10}^{- 6} * 700 π \\ = 29 , 464258 A \\ ( The current passing on {C}_{Δ} at 350 Hz )\end{matrix}$$

$${x}_{A9} = 570 * {10}^{- 6} * 900 π = 1 , 612285 \\ \frac{1}{{x}_{B 9}} = \frac{{10}^{6}}{1530 * 900 π} - 265 , 15 * {10}^{- 6} * 900 π {x}_{B 9} = - 1 , 927053 \\ \frac{1}{{x}_{C 9}} = \frac{{10}^{6}}{470 * 900 π} = - 256 , 15 * {10}^{- 6} * 900 π {x}_{C 9} = 453 , 069769 \\ \frac{1}{{x}_{D 9}} = \frac{{10}^{6}}{320 * 900 π} - 265 , 15 * {10}^{- 6} * 900 π {x}_{D 9} = 2 , 818471 \\ {x}_{E 9} = 790 * {10}^{- 6} * 900 π = 2 , 234571 \\ {x}_{( B - E ) 9} = 456 , 195758 \qquad IV \text{-} 450 Hz$$

$$\frac{1}{{x}_{F 9}} = \frac{{10}^{6}}{2040 * 900 π} - 198 , 8636 * {10}^{- 6} * 900 π {x}_{F 9} = - 2 , 569384$$

$$\frac{1}{{x}_{G 9}} = \frac{{10}^{6}}{1040 * 900 π} - 198 , 8636 * {10}^{- 6} * 900 π {x}_{G 9} = - 4 , 493128$$

$$\frac{1}{{x}_{H 9}} = \frac{{10}^{6}}{420 * 900 π} - 198 , 8636 * {10}^{- 6} * 900 π {x}_{H 9} = 3 , 581008$$

$${x}_{I 9} = 1740 * {10}^{- 6} * 900 π = 4 , 921714$$

$${x}_{( F - I ) 9} = 1 , 44021$$

$$\frac{1}{{x}_{k 9}} = \frac{{10}^{6}}{3060 * 900 π} - 132 , 57 * {10}^{- 6} * 900 π {x}_{K 9} = - 3 , 854317$$

$$\frac{1}{{x}_{L 9}} = \frac{{10}^{6}}{1560 * 900 π} - 132 , 57 * {10}^{- 6} * 900 π {x}_{L 9} = - 6 , 740429$$

$$\frac{1}{{x}_{M 9}} = \frac{{10}^{6}}{940 * 900 π} - 132 , 57 * {10}^{- 6} * 900 π {x}_{M 9} = 894 , 673933$$

$${x}_{N 9} = 4150 * {10}^{- 6} * 900 π = 11 , 738571$$

$${x}_{( K - N ) 9} = 895 , 817758$$

$$\frac{1}{{x}_{O 9}} = \frac{{10}^{6}}{10.183 , 33 * 900 π} - 994 , 317 \; 9 * {10}^{- 6} * 900 π {x}_{O 9} = - 0 , 359999 \\ \frac{1}{{x}_{( A - N ) 9}} = \frac{1}{1 , 612285} - \frac{1}{456 , 195758} + \frac{1}{1 , 44021} + \frac{1}{895 , 817758} \\ {x}_{( A - N ) 9} = 0 , 758789 \\ {x}_{9} = 0 , 758789 - 0 , 359999 = 0 , 38879 \\ {I}_{9} = \frac{11 , 99}{0 , 38879} = 30 , 83927 A \\ \begin{matrix}{V}_{9} = {V}_{A 9} + {V}_{O 9} \\ = {V}_{B 9} + {V}_{C 9} + {V}_{D 9} + {V}_{E 9} + {V}_{O 9} \\ = {V}_{F 9} + {V}_{G 9} + {V}_{H 9} + {V}_{I 9} + {V}_{O 9} = \\ = {V}_{K 9} + {V}_{L 9} + {V}_{M 9} + {V}_{N 9} + {V}_{O 9}\end{matrix}$$

$${V}_{O 9} = 30 , 83927 * - 0 , 359999 = - 11 , 102106$$

$${V}_{A 9} = 11 , 99 + 11 , 102106 = 23 , 092106$$

$${I}_{A 9} = \frac{23 , 092106}{1 , 612285} = 14 , \\ 32259519 A ( The current passing on {L}_{5} at 450 Hz )$$

$${I}_{( B - E ) 9} = \frac{23 , 092106}{456 , 195758} = 0 , \\ 050618 A ( The current passing on {L}_{7} at 450 Hz )$$

$${V}_{B 9} = 0 , 050618 * - 1 , 927053 = - 0 , 097543 V$$

$${I}_{B 1.9} = \frac{- 0 , 097543 * {10}^{6}}{1560 * 900 π} = - 0 , \\ 022105 A ( The current passing on {L}_{5.1} at 450 Hz )$$

$${I}_{B 2.9} = - 0 , 097543 * - 265 , 15 * {10}^{- 6} * 900 π = 0 , \\ 073156 A ( The current passing on {C}_{5.1} at 450 Hz )$$

$${V}_{C 9} = 0 , 050618 * 453 , 069769 = 22 , 933485 V$$

$${I}_{C 1.9} = \frac{22 , 933485 * {10}^{6}}{470 * 900 π} = 17 , \\ 250633 A ( The current passing on {L}_{9.1} at 450 Hz )$$

$${I}_{C 2.9} = 22 , 933485 * - 265 , 15 * {10}^{- 6} * 900 π = - 17 , \\ 200015 A ( The current passing on {C}_{9.1} at 450 Hz )$$

$${V}_{D 9} = 0 , 050618 * 2 , 818471 = 0 , 142665 V$$

$${I}_{D 1.9} = \frac{0 , 142665 * {10}^{6}}{320 * 900 π} = 0 , \\ 157616 A ( The current passing on {L}_{11.1} at 450 Hz )$$

$${I}_{D 2.9} = 0 , 142665 * - 265 , 15 * {10}^{- 6} * 900 π = - 0 , \\ 106998 A ( The current passing on {C}_{11.1} at 450 Hz )$$

$${V}_{E 9} = 0 , 050618 * 2 , 234571 = 0 , 113109 V$$

$${I}_{( F - I ) 9} = \frac{23 , 092106}{1 , 44021} = 16 , \\ 033846 A ( The current passing on {L}_{9} at 450 Hz )$$

$${V}_{F 9} = 16 , 033846 * - 2 , 569384 = - 41 , 197107 V$$

$${I}_{F 1.9} = \frac{- 41 , 197107 * {10}^{6}}{2040 * 900 π} = - 7 , \\ 139526 A ( The current passing on {L}_{5.2} at 450 Hz )$$

$${I}_{F 2.9} = - 41 , 197107 * - 198 , 8636 * {10}^{- 6} * 900 π = 23 , \\ 173368 A ( The current passing on {C}_{5.2} at 450 Hz )$$

$${V}_{G 9} = 16 , 033846 * - 4 , 493128 = - 72 , 042122 V$$

$${I}_{G 1.9} = \frac{- 72 , 042122 * {10}^{6}}{1040 * 900 π} = - 24 , \\ 489843 A ( The current passing on {L}_{7.1} at 450 Hz )$$

$${I}_{G 2.9} = - 72 , 042122 * - 198 , 8636 * {10}^{- 6} * 900 π = 40 , \\ 523686 A ( The current passing on {C}_{7.1} at 450 Hz )$$

$${V}_{H 9} = 16 , 033846 * 3 , 581008 = 57 , 41733 V$$

$${I}_{H 1.9} = \frac{57 , 41733 * {10}^{6}}{420 * 900 π} = 48 , \\ 331085 A ( The current passing on {L}_{11.2} at 450 Hz )$$

$${I}_{H 2.9} = 57 , 41733 * - 198 , 8636 * {10}^{- 6} * 900 π = 40 , \\ 523686 A ( The current passing on {C}_{11.2} at 450 Hz )$$

$${V}_{I .9} = 16 , 033846 * 4 , 921714 = 78 , 914004 V$$

$${I}_{( K - N ) 9} = \frac{23 , 092106}{895 , 817758} = 0 , \\ 025777 A ( The current passing on {L}_{11} at 450 Hz )$$

$${V}_{K 9} = 0 , 025777 * - 3 , 854317 = - 0 , 099352 V$$

$${I}_{K 1.9} = \frac{- 0 , 099352 * {10}^{6}}{3060 * 900 π} = - 0 , \\ 011478 A ( The current passing on {L}_{5.3} at 450 Hz )$$

$${I}_{K 2.9} = - 0 , 099352 * - 132 , 57 * {10}^{- 6} * 900 π = 0 , \\ 037255 A ( The current passing on {C}_{5.3} at 450 Hz )$$

$${V}_{L 9} = 0 , 025777 * - 6 , 740429 = - 0 , 173748 V$$

$${I}_{L 1.9} = \frac{- 0 , 173748 * {10}^{6}}{1560 * 900 π} = - 0 , \\ 039375 A ( The current passing on {L}_{7.2} at 450 Hz )$$

$${I}_{L 2.9} = 0 , 173748 * 894 , 673933 * {10}^{- 6} * 900 π = 0 , \\ 065122 A ( The current passing on {C}_{7.2} and at 450 Hz )$$

$${V}_{M 9} = 0 , 025777 * 894 , 673933 = 23 , 062009 V$$

$${I}_{M 1.9} = \frac{23 , 062009 * {10}^{6}}{940 * 900 π} = 8 , \\ 673654 A ( The current passing on {L}_{9.2} at 450 Hz )$$

$${I}_{M 2.9} = 23 , 062009 * - 132 , 57 * {10}^{- 6} * 900 π = - 8 , \\ 647877 A ( The current passing on {C}_{9.2} at 450 Hz )$$

$${V}_{N 9} = 0 , 025777 * 11 , 738571 = 0 , 302585 V$$

$${V}_{O 9} = - 11 , 102106 V idi . {U}_{O 9} = - 19 , 229411 V$$

$${I}_{L Δ 9} = \frac{- 19 , 229411 * {10}^{6}}{30550 * 900 π} = - 0 , \\ 222529 A ( The current passing on {L}_{Δ} at 450 Hz )$$

$${I}_{C Δ 9} = - 19 , 229411 * - 331 , 4393 * {10}^{- 6} * 900 π = 18 , \\ 027567 A ( The current passing on {C}_{Δ} at 450 Hz )$$

$$V \text{-} 550 Hz$$

$${x}_{A 11} = 570 * {10}^{- 6} * 1100 π = 1 , 970571$$

$$\begin{matrix}\frac{1}{{x}_{B 11}} = \frac{{10}^{6}}{1530 * 1100 π} - 265 , 15 * {10}^{- 6} * 1100 π {x}_{B 11} \\ = - 1 , 374371\end{matrix}$$

$$\begin{matrix}\frac{1}{{x}_{C 11}} = \frac{{10}^{6}}{470 * 1100 π} = - 256 , 15 * {10}^{- 6} * 1100 π {x}_{C 11} \\ = - 3 , 319802\end{matrix}$$

$$\begin{matrix}\frac{1}{{x}_{D 11}} = \frac{{10}^{6}}{320 * 1100 π} - 265 , 15 * {10}^{- 6} * 1100 π {x}_{D 11} \\ = - 78 , 518767\end{matrix}$$

$${x}_{E 11} = 790 * {10}^{- 6} * 1100 π = 2 , 731142$$

$${x}_{( B - E ) 11} = - 80 , 481798$$

$$\begin{matrix}\frac{1}{{x}_{F 11}} = \frac{{10}^{6}}{2040 * 1100 π} - 198 , 8636 * {10}^{- 6} * 1100 π {x}_{F 11} \\ = - 1 , 832483\end{matrix}$$

$$\begin{matrix}\frac{1}{{x}_{G 11}} = \frac{{10}^{6}}{1040 * 1100 π} - 198 , 8636 * {10}^{- 6} * 1100 π {x}_{G 11} \\ = - 2 , 442874\end{matrix}$$

$$\begin{matrix}\frac{1}{{x}_{H 11}} = \frac{{10}^{6}}{420 * 1100 π} - 198 , 8636 * {10}^{- 6} * 1100 π {x}_{H 11} \\ = 829 , 627749\end{matrix}$$

$${x}_{I 11} = 1740 * {10}^{- 6} * 1100 π = 6 , 015428$$

$${x}_{( F - I ) 11} = 831 , 36791$$

$$\begin{matrix}\frac{1}{{x}_{K 11}} = \frac{{10}^{6}}{3060 * 1100 π} - 132 , 57 * {10}^{- 6} * 1100 π {x}_{K 11} \\ = - 2 , 748874\end{matrix}$$

$$\begin{matrix}\frac{1}{{x}_{L 11}} = \frac{{10}^{6}}{1560 * 1100 π} - 132 , 57 * {10}^{- 6} * 1100 π {x}_{L 11} \\ = - 3 , 664442\end{matrix}$$

$$\begin{matrix}\frac{1}{{x}_{M 11}} = \frac{{10}^{6}}{940 * 1100 π} - 132 , 57 * {10}^{- 6} * 1100 π {x}_{M 11} \\ = - 6 , 640367\end{matrix}$$

$${x}_{N 11} = 4150 * {10}^{- 6} * 1100 π = 14 , 347142$$

$${x}_{( K - N ) 11} = 1 , 293459$$

$$\begin{matrix}\frac{1}{{x}_{O 11}} = \frac{{10}^{6}}{10.183 , 33 * 1100 π} - 994 , 3179 * {10}^{- 6} * 1100 π {x}_{O 11} \\ = - 0 , 293333\end{matrix}$$

$$\frac{1}{{x}_{( A - N ) 11}} = \frac{1}{1 , 970571} - \frac{1}{80 , 481798} + \frac{1}{831 , 36791} + \frac{1}{1 , 293459}$$

$${x}_{( A - N ) 11} = 0 , 787795$$

$${x}_{11} = 0 , 787795 - 0 , 293333 = 0 , 494462$$

$${I}_{11} = \frac{9 , 77}{0 , 494462} = 19 , 758849 A$$

$$\begin{matrix}{V}_{11} = {V}_{A 11} + {V}_{O 11} \\ = {V}_{B 11} + {V}_{C 11} + {V}_{D 11} + {V}_{E 11} + {V}_{O 11} \\ = {V}_{F 11} + {V}_{G 11} + {V}_{H 11} + {V}_{I 11} + {V}_{O 11} \\ = {V}_{K 11} + {V}_{L 11} + {V}_{M 11} + {V}_{N 11} + {V}_{O 11}\end{matrix}$$

$${V}_{O 11} = 19 , 758849 * - 0 , 293333 = - 5 , 795922 V$$

$${V}_{A 11} = 9 , 77 + 5 , 795922 = 15 , 565922 V$$

$$\begin{matrix}{I}_{A 11} = \frac{15 , 565922}{1 , 970571} \\ = 7 , 899193 A \\ ( The current passing on {L}_{5} at 550 Hz )\end{matrix}$$

$$\begin{matrix}{I}_{( B - E ) 11} = \frac{15 , 565922}{- 80 , 481798} \\ = - 0 , 193409 A \\ ( The current passing on {L}_{7} at 550 Hz )\end{matrix}$$

$${V}_{B 11} = - 0 , 193409 * - 1 , 374371 = 0 , 265815 V$$

$$\begin{matrix}{I}_{B 1.11} = \frac{0 , 265815 * {10}^{6}}{1560 * 1100 π} \\ = 0 , 012191 A \\ ( The current passing on {L}_{5.1} at 550 Hz )\end{matrix}$$

$$\begin{matrix}{I}_{B 2.11} = 0 , 265815 * - 265 , 15 * {10}^{- 6} * 1100 π \\ = - 0 , 243662 A \\ ( The current passing on {C}_{5.1} at 550 Hz )\end{matrix}$$

$${V}_{C 11} = - 0 , 193409 * - 3 , 319802 = 0 , 642079 V$$

$$\begin{matrix}{I}_{C 1.11} = \frac{0 , 642079 * {10}^{6}}{470 * 1100 π} \\ = 0 , 39516 A \\ ( The current passing on {L}_{9.1} at 550 Hz )\end{matrix}$$

$$\begin{matrix}{I}_{C 2.11} = 0 , 642079 * - 265 , 15 * {10}^{- 6} * 1100 π \\ = - 0 , 588569 A \\ ( The current passing on {C}_{9.1} at 550 Hz )\end{matrix}$$

$${V}_{D 11} = - 0 , 193409 * - 78 , 518767 = 15 , 186236 V$$

$$\begin{matrix}{I}_{D 1.11} = \frac{15 , 186236 * {10}^{6}}{320 * 1100 π} \\ = 13 , 727227 A \\ ( The current passing on {L}_{11.1} at 550 Hz )\end{matrix}$$

$$\begin{matrix}{I}_{D 2.11} = 15 , 186236 * - 265 , 15 * {10}^{- 6} * 1100 π \\ = - 13 , 920636 A \\ ( The current passing on {C}_{11.1} at 550 Hz )\end{matrix}$$

$${V}_{E 11} = - 0 , 193409 * 2 , 731142 = - 0 , 528227 V$$

$$\begin{matrix}{I}_{( F - I ) 11} = \frac{15 , 565922}{831 , 36791} \\ = 0 , 018723 A \\ ( The current passing on {L}_{9} at 550 Hz )\end{matrix} \\ {V}_{F 11} = 0 , 018723 * - 1 , 832483 = -- 0 , 0343095 V \\ \begin{matrix}{I}_{F 1.11} = \frac{- 0 , 0343095 * {10}^{6}}{2040 * 1100 π} \\ = - 0 , 00486 A \\ ( The current passing on {L}_{5.2} at 550 Hz )\end{matrix} \\ \begin{matrix}{I}_{F 2.11} = - 0 , 0343095 * - 198 , 8636 * {10}^{- 6} * 1100 π \\ = 0 , 023587 A \\ ( The current passing on {C}_{5.2} at 550 Hz )\end{matrix} \\ {V}_{G 11} = 0 , 018723 * - 2 , 442784 = - 0 , 045736 V \\ \begin{matrix}{I}_{G 1.11} = \frac{- 0 , 045736 * {10}^{6}}{1040 * 1100 π} \\ = - 0 , 01272 A \\ ( The current passing on {L}_{7.1} at 550 Hz )\end{matrix} \\ \begin{matrix}{I}_{G 2.11} = - 0 , 045736 * - 198 , 8636 * {10}^{- 6} * 1100 π \\ = 0 , 031443 A \\ ( The current passing on {C}_{7.1} at 550 Hz )\end{matrix}$$

$${V}_{H 11} = 0 , 018723 * 829 , 627749 = 15 , 53312 V$$

$$\begin{matrix}{I}_{H 1.11} = \frac{15 , 53312 * {10}^{6}}{420 * 1100 π} \\ = A ( The current passing on {L}_{11.2} at 550 Hz )\end{matrix}$$

$$\begin{matrix}{I}_{H 2.11} = 15 , 53312 * - 198 , 8636 * {10}^{- 6} * 1100 π \\ = - 10 , 679018 A \\ ( The current passing on {C}_{11.2} at 550 Hz )\end{matrix}$$

$${V}_{I .11} = 0 , 018723 * 6 , 015428 = 0 , 112626 V$$

$$\begin{matrix}{I}_{( K - N ) 11} = \frac{15 , 565922}{1 , 293459} \\ = 12 , 034337 A \\ ( The current passing on {L}_{11} at 550 Hz )\end{matrix}$$

$${V}_{K 11} = 12 , 034337 * - 2 , 748874 = - 33 , 080876 V$$

$$\begin{matrix}{I}_{K 1.11} = \frac{-- 33 , 080876 * {10}^{6}}{3060 * 1100 π} \\ = - 3 , 127074 A \\ ( The current passing on {L}_{5.3} at 550 Hz )\end{matrix}$$

$$\begin{matrix}{I}_{K 2.11} = - 33 , 080876 * - 132 , 57 * {10}^{- 6} * 1100 π \\ = 15 , 161409 A \\ ( The current passing on {C}_{5.3} at 550 Hz )\end{matrix}$$

$${V}_{L 11} = 12 , 034337 * - 3 , 664442 = - 44 , 099129 V$$

$$\begin{matrix}{I}_{L 1.11} = \frac{- 44 , 099129 * {10}^{6}}{1560 * 1100 π} \\ = - 8 , 176888 A \\ ( The current passing on {L}_{7.2} at 550 Hz )\end{matrix}$$

$$\begin{matrix}{I}_{L 2.11} = - 44 , 099129 * - 132 , 57 * {10}^{- 6} * 1100 π \\ = 20 , 211223 A \\ ( The current passing on {C}_{7.2} at 550 Hz )\end{matrix}$$

$${V}_{M 11} = 12 , 034337 * - 6 , 640367 = - 79 , 912414 V$$

$$\begin{matrix}{I}_{M 1.11} = \frac{- 79 , 912414 * {10}^{6}}{940 * 1100 π} \\ = - 24 , 590596 A \\ ( The current passing on {L}_{9.2} at 550 Hz )\end{matrix}$$

$$\begin{matrix}{I}_{M 2.11} = - 79 , 912414 * - 132 , 57 * {10}^{- 6} * 1100 π \\ = 36 , 624932 A \\ ( The current passing on {C}_{9.2} at 550 Hz )\end{matrix}$$

$${V}_{N 11} = 12 , 034337 * 14 , 347142 = 172 , 658341 V$$

$${V}_{O 11} = - 5 , 795922 V idi . {U}_{O 11} = - 10 , 038831 V$$

$$\begin{matrix}{I}_{L Δ 11} = \frac{- 10 , 038831 * {10}^{6}}{30550 * 1100 π} \\ = - 0 , 09505 A \\ ( The current passing on {L}_{Δ} at 550 Hz )\end{matrix}$$

$$\begin{matrix}{I}_{C Δ 11} = - 10 , 038831 * - 331 , 4393 * {10}^{- 6} * 1100 π \\ = 11 , 502823 A \\ ( The current passing on {C}_{Δ} at 550 Hz )\end{matrix}$$

If we list the values we have found and the characteristics of the materials: The scope of protection for this application is to be determined by the claims, and can certainly not be limited to those explained above for exemplary purposes. It is clear that the innovation put forward by a technical expert in the invention, can also be put forward by using similar structures and/or this structure may be applied in other fields with similar purposes used in the related technique. Therefore, it is evident that such structures shall lack the criteria of overcoming the innovation and especially, the existing condition of the technique.

1. A harmonic absorber for eliminating the harmonics that occur due to non-linear loads, in a system comprising at least one network transformer, preferably a power factor correction, in order to correct the cos φ value of the system at which it has been connected and electrical loads characterized in that the absorber consists of at least one harmonic hole circuit that damps the harmonic current or currents applied to it and a harmonic separator circuit, which separates the harmonic currents existing in the network from the other components of the network and then applies each resultant individual harmonic current to said harmonic hole circuit in order that its elimination can be achieved.

2. A harmonic absorber according to claim 1, characterised in that the harmonic hole circuit constitutes a delta connection with of barrier circuits comprising power reactance inductors and power capacitors parallel to each other.

3. A harmonic absorber according to claim 1, wherein the harmonic hole circuit forms a star connection of barrier circuits, which consist of power reactance inductors and power capacitors connected parallel to each other.

4. A harmonic absorber according to claim 1, characterised in that the harmonic hole circuit comprises parallel power reactance inductors and power capacitors, to which each individual harmonic current is applied separately.

5. A harmonic absorber according to claim 1, containing harmonic barrier circuits in the same number as the harmonic currents, which are required to be suppressed.

6. A harmonic absorber according to claim 1, including at least one power reactance inductor for attracting a harmonic current, which is required to be damped, to said harmonic separator and then transferring the harmonic current directly to said harmonic hole.

7. A harmonic absorber according to claim 1, comprising serially connected harmonic barrier circuits, the number of which is determined according to the required sensitivity for conducting only the harmonic, whose elimination is desired, and barring the other harmonics.

8. A harmonic absorber according to claim 7, having harmonic barrier circuits comprising power reactance inductors and power capacitors, whose values are calculated in accordance with the components of the harmonic current that is requested to be eliminated and which are connected in parallel.

9. A method for absorbing the harmonics that occur due to non-linear loads, in a network comprising at least one network transformer, preferably including a power factor correction, in order to correct the cos φ value of the system to which it has been connected and electrical loads, the method being characterized by:
obtaining individual harmonic currents by separating the harmonic currents, which, for the system, have to be eliminated from the network and from each other, using at least one harmonic separator and damping the harmonic currents thus separated, by using at least one harmonic hole.

10. A method according to claim 9, wherein to eliminate the harmonics that are formed in the network, all harmonic currents except the ones which are required to be attracted via the harmonic separator are filtered via harmonic barriers in order to obtain the harmonic currents.

11. A method according to claim 9, wherein to eliminate the harmonics that are formed in the network, the harmonic current, which is required to be damped, is attracted to said harmonic hole via at least one harmonic transferor, in order to obtain the harmonic currents.

12. A method according to claim 11, wherein the harmonic transferor comprises at least one power reactance inductor, whose values are calculated for drawing the alternative signal at the requested frequency.

13. A method according to claim 9, wherein to eliminate the harmonics that occur in the network, said harmonic separator and harmonic hole, which constitute the harmonic absorber, are connected to a connection point directly after the main switch and directly before all other elements in the system, to protect the system.
